(19) United States
(12) Patent Application Publication
(10) Pub. No.: US 2004/0244427 A1
(43) Pub. Date: Dec. 9, 2004

(54) Zero-twist glass yarn, its production method and glass fabric using zero-twist glass yarn as weft yarn

(75) Inventor: C.F. Charles Lee, Taipei (TW)

Correspondence Address: STEVENS DAVIS MILLER & MOSHER, LLP, 1615 L STREET, NW, SUITE 850, WASHINGTON, DC, 20036, US

(73) Assignee: PFG FIBER GLASS CORPORATION, Taipei (TW)

(21) Appl. No.: 10/856,930

(22) Filed: Jun. 1, 2004

(30) Foreign Application Priority Data
Jun. 5, 2003 (TW) 92115304

(51) Int. Cl. C03B 37/075; C03B 37/022; C03B 37/04

(52) U.S. Cl. 65/438; 65/447; 65/448; 65/469

(57) ABSTRACT

A method for producing zero-twist glass yarn employing a special sizing agent for sizing procedure during spinning process that enables a loss on ignition of the special sizing agent which makes up 0.8˜1.6 Wt % of the glass yarn and a moisture content less than 0.2% of the glass yarn after drying the forming package formed through spinning, sizing and winding procedure with which the zero-twist glass yarn is obtained without need of twist fixing process; moreover, the zero-twist glass yarn produced therefrom possesses the tensile strength better than that of the conventional twisted glass yarn, and, when used as weft yarn, may substantially increase the tensile strength of the glass fabric.

### BACKGROUND OF THE PRESENT INVENTION

1. Field of the Present Invention

The invention relates to a zero-twist glass yearn and its production method, particularly the method in which special sizing agent is used during melt spinning process to make the zero-twist glass yarn obtained through the procedures of spinning, signing and winding into a spool or forming package and it able to be used directly for weaving without need of twist fixing processing.

2. Description of Prior Act

Presently the raw material used for making glass fabric electronic sleeve, reinforced paper, reinforced belt, silicon shaft and electric insulation material etc. is glass yarn which has to undergo the twist fixing process to obtain twisted glass yarn during production process. As shown in FIG. 1 and FIG. 2 are the production method of twisted glass yarn which is usually divided into three major processes i.e. melting glass material (I), melt spinning (II) and twist fixing (III).

The process of melting glass material (I) comprises two steps of mixing raw materials and melting glass material which is for mixing the raw materials of including silica sand, limestone, clay, boric acid, fluorite, sodium sulfate and soda ash by according to specific proportion, and heating the mixture of raw materials in glass furnace to obtain melting glass paste.

The process of melt spinning (II) comprises the steps of spinning, sizing and winding. The glass paste obtained from process (I) is arranged to pass and flow out from the orifice of a spinneret to form continuous strands, i.e. filaments that are then immediately cooled by means of water mist jet. Subsequently the cooled and hardened fibers undergo sizing procedure by employing sizing apparatus to size conventional sizing agent for glass yarn, and hundreds of filament are then collected by collecting device to form strand of yarn with average diameter of single filament around 5 to 30 microns, these filaments are then wound into a spool or forming package by winding machine (10).

Finally, in twist fixing process (III) the glass yarn cake (10) obtained from melt spinning process (II) is unwound on the yarn feeder of a twisting machine to undergo twist fixing process by means of pig tail and steel ring, and then the twisted glass yarn is wound onto the turning plastic sleeve to form cone-shaped twisted glass yarn product (20) for producing glass fabric (30).

In the conventional method for producing the twisted glass yarn as mentioned above the conventional sizing agent for glass yarn is used during melt spinning process (II), particularly, various types of twist fixing process must be followed to obtain the final product of glass yarn (twisted) that results in the unavoidable extra production cost due to twist fixing processing.

However the twist fixing process (III) of the conventional method for producing twisted glass yarn may be omitted if the zero-twist glass yarn production method as disclosed in the present invention is employed, and the physical properties of the zero-twist yarn obtained by applying the method of the present invention much better than those of the conventional twisted glass yarn such as the better tensile strength which, when the zero-twist glass yarn of the invention is used as weft yarn of the glass fabric, may substantially increase the tensile strength of the glass fabric in weft sense.

### SUMMARY OF THE PRESENT INVENTION

The major purpose of the invention is to provide a method for producing zero-twist glass yarn by employing the special sizing agent containing the ingredients disclosed by the invention during melt spinning process (II). The filaments so obtained are then wound into a spool or forming package which after completion of drying and moisture regain process will form zero-twist glass yarn for producing glass fabric, electronic sleeve, reinforced paper, reinforced belt, silicon shaft material and, electric insulation material etc., especially without need to undergo twist fixing process (III).

The minor purpose of the invention is to provide a method for producing zero-twist glass yarn without need of twist fixing processing that may save the extra cost spent for twist fixing processing, and possesses the advantage of saving overall production cost. Besides, since the zero-twist glass yarn produced by the method of the invention has superior tensile strength it is capably used for producing the glass fabric special for CCL base material, particularly, when the zero-twist glass yarn of the invention is used as the weft yarn the tensile strength of the glass fabric is substantially increased.

### BRIEF DESCRIPTION OF THE DRAWING FIGURES

FIG. 1 is the production process for producing conventional twisted glass yarn and glass fabric containing twisted glass yarn.

FIG. 2 is general flow diagram for producing conventional twisted glass yarn and glass fabric containing twisted glass yarn.

FIG. 3 is the production process of this present invention for producing zero-twist glass yarn and glass fabric containing zero-twist glass yarn of the invention.

FIG. 4 is a flow diagram for producing zero-twist glass yarn and glass fabric containing zero-twist glass yarn of this present invention.

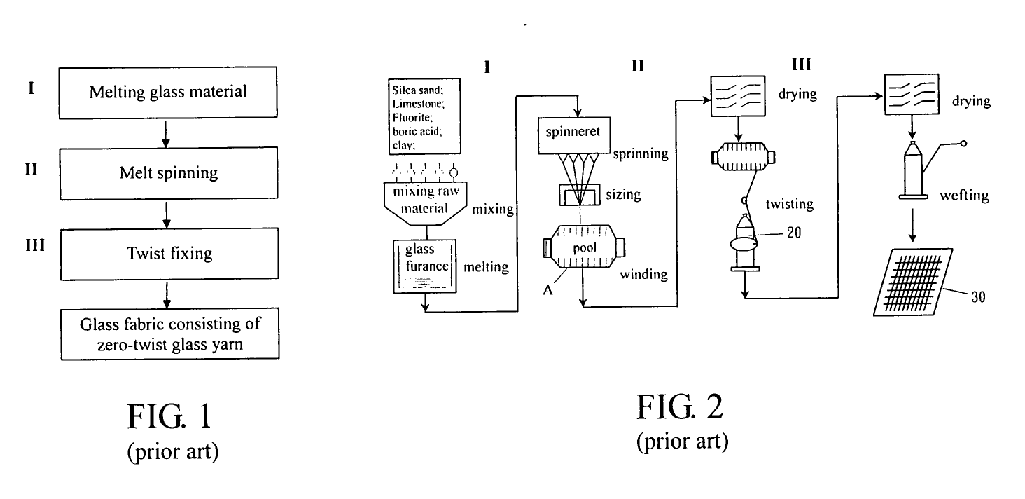

### DETAILED DESCRITION OF THE PREFERRED EMBODIMENTS

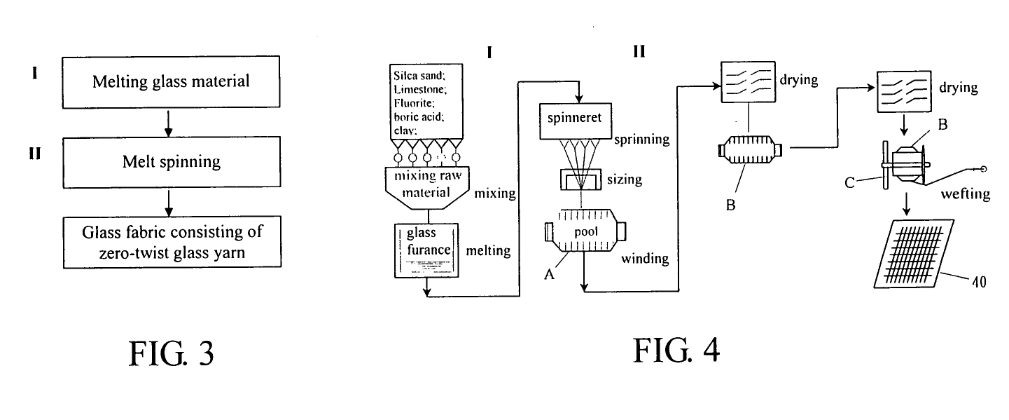

Referring to FIG. 3 and FIG. 4, the method for producing zero-twist glass yarn as disclosed in this present invention comprises two major processes including melting glass materials (I) and melt spinning (II) especially without need of the process of twist fixing (III) which is needed for producing the conventional twisted glass yarn.

The process of melting glass material (I) is the same as that of the conventional process of melting glass material (I) which comprises two steps of mixing raw materials and melting glass material, i.e. mixing the raw materials including silica sand, limestone, kaolin, boric acid, fluorite, sodium sulfate and soda ash by according to specific proportion and then put the mixture in glass furnace to melt it into melting glass paste.

During the melt spinning process (II) of this invention, the processing steps are the same as that of the conventional melt spinning process (II) which includes the steps of spinning, sizing and winding in which the meeting glass paste obtained from process (I) is arranged to pass and flow out from the spinning orifice of a platinum spinneret under gravitational force, and then cooled by water mist jet immediately after the glass paste droplets emerge from the orifice to become filaments under the pulling effect of the gravitational force, and then the hundreds glass filament undergo sizing step by means of sizing apparatus and are collected into strand by employing collecting device. Finally the strand is wound under high winding speed into glass yarn cake (A) by employing high-speed winding machine. However, during the melt spinning process (II) of the invention the size agent used for sizing step is a specially designed size agent containing the specific ingredients disclosed by the invention which are different from that of the conventional sizing agent for gluing conventional glass yarn. In other words the specific sizing ingredient and formula used for sizing step is the key technique of the production method disclosed in the invention that enables the omission of the twist fixing process (III) in the production of zero-twist glass yarn, and enables an improvement both in quality and physical property of the glass fabric containing zero-twist glass yarn.

Hence, the key point of the invention is having the glass yarn cake (A) obtained from high speed winding by winding machine be processed by natural moisture regain and dried by oven, vacuum oven or high frequency drying device under controlled condition to achieve a loss on ignition around 0.8˜1.6 wt % and water content less than 0.2% of the sizing agent of forming package (A), so that after completion of drying step under controlled condition the forming package (A) can be formed into zero-twist glass yarn (B) without twist fixing processing.

In addition, as shown in FIG. 4, the zero-twist glass yarn (B) of the invention can be directly mounted on the package holder (C) of weft yarn holder for filling in weaving glass fabric (40) containing zero-twist glass yarn (B), and the fabric (40) containing zero-twist glass yarn (B) of the invention can be used for the base material of PCB or CCL.

In addition to the solid content which makes 5.0˜8.0 wt % of the solution of sizing agent, the sizing agent of the invention further contains:

(a) Film former, making 1.5˜4.0 w% of sizing agent solution: Types of ingredient include starch contained things such as corn, wheat and potato etc.; vinyl emulsions such as polyvinyl acetate, acrylic or styrene-based group and polyvinyl propionate emulsions etc.; polycondensate emulsions such as the polyester emulsions, polyurethane, epoxies, and epoxy ester etc; and polyvinyl pyrrolidone, among which the corn and/or potato starch is the preferred embodiment.

(b) Lubricant, making 1˜3 Wt % of sizing agent solution. Types of lubricant include modified hydrogenated cotton seed oil; corn oil; soybean oil; fatty wax; and other kinds of hydrogenatives, or vegetable oil etc., among which the modified hydrogenated soybean oil and/or fatty wax is the preferred embodiment.

(c) Softener, making 0.1˜0.5 wt % of sizing agent Type of softener include amine group such as primary amine salt; ethoxylated amines group such as the product obtained from the reaction between primary amine and ethoxylated amines group; quaternary ammonium salt; and other derivatives cationic such as the derivatives of amide and alkyl imidazolines; among which amide and/or alkyl imidazolines is the preferred embodiment.

(d) Emulsifying agent, making 0.2˜0.5 wt % of sizing agent solution. Types of emulsifier include non-ionic surfactant agent such as polyoxyethylene sorbitan monooleate, polyoxidative vinyl, among which the polyoxyethylene sorbitan monooleate is the preferred embodiment.

(e) Coupling agent, making 0˜0.4 wt % of sizing agent solution Types of coupling agent include complex compound of chromium and titanium; and coupling agent of silane group, among which the silane group-coupling agent is the preferred embodiment.

(f) Deionized water, making 96˜82 wt % of sizing agent solution.

### EXAMPLE OF EMBODIMENT

The sizing agent A and sizing agent B as shown in Table 1 are preferred embodiment of the method for producing zero-twist glass yarn as disclosed in the invention, which are used in melt spinning process (II) for gluing zero-twist glass yarn, and the zero-twist glass yarn is further used for producing the glass fabric containing zero-twist yarn. And, the physical property of the zero-twist glass yarn and the surface physical property of the glass fabric containing zero-twist glass yarn are shown in Table 2 and Table 3. Also the test results of moisture absorbability, bursting distortion plate test, distortion plate test and bending test of the glass fabric containing zero twist glass yarn which has been soaked in epoxy and hardened for CCL base material are shown in Table 4.

And, the sizing agent C as shown in Table 1, used as a comparison example to the sizing agent A and the sizing agent B, is for producing the conventional twisted glass yarn which has undergone the twist fixing process (III). Then the twisted glass yarn is used for producing the conventional glass fabric and the glass fabric for CCL base material.

According to the test results in Table 2 and Table 3, it proves that the zero-twist glass yarn of the present invention has much more better tensile strength (g/tex), flying ability (g), softness (cm) and branching tendency ability [L(cm), X(cm)] than those of twisted glass yarn, particularly, when the zero-twist glass yarn of the invention is used as weft yarn of glass fabric an apparent increase in tensile strength in weft sense can be achieved. It is also proved according to the test result in Table 4 that the CCL products derived from the zero-twist glass yarn of the invention is better than the conventional glass fabric product containing with twisted glass yarn both in physical property and quality.

TABLE 1

| | Item | | |
|---|---|---|---|
| Sizing agent | Sizing agent A, | Sizing agent B, | Sizing agent C, |
| Component wt % | zero-twist | zero-twist | twisted |
| Film forming agent | 3.90 | 2.60 | 4.07 |
| Lubricant | 1.50 | 2.00 | 1.45 |
| Softener | 0.45 | 0.11 | 1.31 |
| Emulsification agent | 0.30 | 0.40 | 0.21 |
| Coupling agent | 0.30 | 0.28 | 0 |
| Deionized water | 87.35 | 88.56 | 86.74 |
| Solid content | 6.20 | 6.05 | 6.25 |

TABLE 2

| | | Item | | |
|---|---|---|---|---|
| Quality and | | Glass yarn A, | Glass yarn B, | Glass yarn C, |
| Physical property | | zero-twist | zero-twist | twisted |
| Loss on ignition | | 1.15 | 1.00 | 1.20 |
| (LOI %) | | | | |
| Water (H2O %) | | 0.12 | 0.10 | <0.20 |
| Tensile strength (g/tex) | | 60.90 | 69.95 | 51.83 |
| Width (mm) | | 0.80 | 0.87 | 0.27 |
| Friction Coefficient | | 0.293 | 0.219 | 0.341 |
| Flying ability (g) | | 65.84 | 73.31 | 56.96 |
| Softness (cm) | | 7.3 | 8.7 | 4.1 |
| Branching | L (cm) | 1.30 | 1.80 | 1.03 |
| tendency | X (cm) | 0.60 | 0.60 | 0.33 |

Note:
The physical properties of the glass yarn shown above are obtained by employing of the following test methods:
1. Loss on ignition, water content, tensile strength: Test data are obtained by according to the test method specified in ASTM-D578.
2. Friction coefficient: Test data are obtained by using the instrument with serial no. SDL 96/8 provided by SDL Corporation.
3. Flying ability: By putting the test sample into the nozzle of a weaving machine, set nozzle pressure at 2 kg, measure the weight (g) of the sample flowing through the nozzle within a time period of one minute.
4. Softness: By winding a sample with length of 30 meters on a cylindrical object with diameter of 10 cm, then remove the sample from the cylindrical object, and put it freely on a flat surface. Measure the max. diameter of circular shaped sample along transverse direction (cm).
5. Branching tendency: To attach a mass with weight of 100 g. to the bottom end of a sample with length of 30 meters for a time period of one minute. Then cut the sample along the location a distance 5 cm away from the mass. To measure and record the branching tendency (cm) by a rule. Wherein L means longitudinal direction, and X means transverse direction.

TABLE 3

| | Item | | |
|---|---|---|---|
| Physical | Glass fabric A, | Glass fabric B, | Glass fabric C, |
| Property of | with zero-twist | with zero-twist | with twisted |
| fabric surface | glass yarn | glass yarn | glass yarn |
| Fabric quality | Better | Better | Better |
| Tensile strength | 24.6 | 30.1 | 25.03 |
| In warp sense (kg/cm) | | | |
| Tensile strength | 18.9 | 25.7 | 16.97 |
| In weft sense (kg/cm) | | | |
| Permeability | 0.204 | 0.304 | 0.360 |
| (m³/m², min) | | | |
| Thickness (mm) | 0.170 | 0.172 | 0.176 |

TABLE 4

| | | Item | | |
|---|---|---|---|---|
| | | Glass fabric A, | Glass fabric B, | Glass fabric C, |
| Physical | | with zero-twist | with zero-twist | with twisted glass |
| Property of CCL | | glass yarn | glass yarn | yarn |
| PCT 60′ | Absorption | 0.427 | 0.274 | 0.293 |
| Bursting Plate | (%) | | | |
| Test | 260° C. | Without explosion | Without explosion | Without explosion |
| | 288° C. | Without explosion | Without explosion | Without explosion |
| PCT 120′ | Absorption | 0.622 | 0.447 | 0.430 |
| Bursting Plate | (%)) | | | |
| Test | 260° C. | Without explosion | Without explosion | Without explosion |
| | 288° C. | Without explosion | Without explosion | Without explosion |
| PCT 180′ | Absorption | 0.777 | 0.550 | 0.530 |
| Bursting Plate | (%) | | | |
| Test | 260° C. | Without explosion | Without explosion | Without explosion |
| | 288° C. | Without explosion | Without explosion | Without explosion |
| Distortion | 305 × 305 | 0.23 | 0.03 | 0.35 |
| Plate test | 510 × 340 | 0.58 | 0.13 | 0.55 |
| (mm/mm) | | | | |
| Bending test | Warp sense | 633.77 | 560.20 | 535.31 |
| (N/mm²) | Weft sense | 476.37 | 428.40 | 410.09 |

What is claimed is:

1. A method for producing zero-twist glass yarn comprising the process of melting glass material (I) wherein the glass material is mixed and melted to form molten glass paste; and the process of melt spinning (II) wherein the molten glass paste obtained from process (I) undergoes the steps of spinning, sizing by using sizing agent containing 5˜8 wt % of solid substance and winding into a spool (A) which in turn passes drying step to enable a Loss on Ignition of 0.8˜1.6 wt % of the glass yarn and moisture content less than 0.2% to form zero-twist glass yarn without need to undergo the twist fixing step; wherein during said melt spinning process (II) the sizing agent used for sizing step contains (a) film forming agent 1.5˜4.0 wt %, Lubricant 1˜3 wt %, (c) Softener 0.1˜0.5 wt % (d) emulsification agent 0.2˜0.5 wt % (e) coupling agent 0˜0.4 wt % and (f) deionized water 96˜82 wt %.

2. The production method as defined in claim 1, wherein the film forming agent (a) of the sizing agent is selected from one of the substances of starch, vinyl emulsions, polycondensate emulsions and polyvinyl pyrrolidone; the lubricant (b) of the sizing agent is selected from one of the substances of modified hydrogenated cotton seed oil, corn oil, soybean oil, fatty wax and vegetable oil; the softener (c) is selected from one of the substances of Amine group, ethoxylated amines group, quaternary ammonium salt and other cationic derivatives; the emulsifying agent (d) is selected from one of the substances of non-ionic surfactant agent and polyoxyethylene sorbitan monooleate; and the coupling agent (e) is selected from one of the substances of chromium complex compound, titanium complex compound and silane group chemicals.

3. The production method as defined in claim 1 wherein the film forming agent (a) of the sizing agent is corn and/or potato starch; the lubricant (b) of the sizing agent is modified soybean oil and/or fatty wax; the softener is acid amide and/or alkyl imidazolines derivatives; the emulsification agent (c) of the sizing agent is polyoxyethylene sorbitan monooleate; the coupling agent (e) of the sizing agent is silane group chemicals; and the sizing agent also contains deionized water (f).

4. The production method as defined in claim 1 wherein the drying method for controlling the Loss on Ignition of the sizing agent of the glass yarn to be within 0.8˜1.6 wt % and the moisture content to be less than 0.2% of the glass yarn is achieved by any one drying methods of natural moisture regain, oven drying vacuum oven drying or high frequency drying.

5. A zero-twist glass yarn directly produced by the production method as defined in claim 1, which is provided with physical property of tensile strength of 60.90˜69.95 g/tex.

6. A glass fabric containing zero-twist glass yarn having its weft yarn formed with the zero-twist glass yarn as defined in claim 5.

7. The glass fabric made of zero-twist glass yarn as defined in claim 6 possessing the physical properties of tensile strength in weft sense of 18.9˜25.7 kg/cm and permeability of 0.204˜0.304 m³/m² min.
